(19) United States
(12) Patent Application Publication
(10) Pub. No.: US 2021/0041538 A1
(43) Pub. Date: Feb. 11, 2021

(54) LIGHT DETECTION AND RANGING SENSORS WITH OPTICS AND SOLID-STATE DETECTORS, AND ASSOCIATED SYSTEMS AND METHODS

(71) Applicant: SZ DJI TECHNOLOGY CO., LTD., Shenzhen City (CN)

(72) Inventors: Guoguang ZHENG, Shenzhen City (CN); Mingyu WANG, Shenzhen City (CN); Xiaoping HONG, Shenzhen City (CN); Xiang LIU, Shenzhen City (CN); Huai HUANG, Shenzhen City (CN)

(21) Appl. No.: 17/081,984

(22) Filed: Oct. 27, 2020

Related U.S. Application Data
(63) Continuation of application No. PCT/CN2018/085164, filed on Apr. 28, 2018.

(51) Int. Cl. G01S 7/481; G02B 5/32; G02B 27/30; G02B 26/10

(52) U.S. Cl. CPC G01S 7/4817; G01S 7/4816; G02B 5/32; G02B 26/101; G02B 27/30; G02B 26/108; G01S 7/4815

(57) ABSTRACT

Systems and techniques associated light detection and ranging (LIDAR) applications are described. In one representative aspect, techniques can be used to implement a sensor device. The sensor device includes an electromagnetic energy emitter module positioned to emit an electromagnetic energy beam directed to one or more objects, a beam steering module positioned to receive at least a portion of the electromagnetic energy beam that is reflected from the one or more objects, and an array of receiver units positioned to convert the portion of the electromagnetic energy beam into multiple electrical signals. The beam steering module is further positioned to direct the portion of the electromagnetic energy beam to the array of receiver units, with individual receiver units positioned to detect multiple optical signals from the portion of the electromagnetic energy beam and convert the multiple optical signals into electrical signals.

### TECHNICAL FIELD

The present disclosure is directed generally to autonomous sensing, and more specifically, to components, systems and techniques associated with light detection and ranging (LIDAR) applications.

### BACKGROUND

With their ever-increasing performance and lowering cost, intelligent machinery is now extensively used in many fields. Representative missions include crop surveillance, real estate photography, inspection of buildings and other structures, fire and safety missions, border patrols, and product delivery, among others. For obstacle detection as well as for other functionalities, it is beneficial for intelligent machinery to be equipped with obstacle detection and surrounding environment scanning devices. Light detection and ranging (LIDAR, also known as “light radar”) offers reliable and accurate detection. However, to obtain an accurate model of the external environment, the LIDAR system requires a high density of data signals from the environment. Such a requirement can increase the complexity and cost of manufacturing the optical and electrical components of the LIDAR system. Accordingly, there remains a need for improved techniques for implementing LIDAR systems carried by intelligent machinery and other objects.

### SUMMARY

The present disclosure is directed to components, systems and techniques associated with light detection and ranging (LIDAR) systems.

In one representative aspect, the disclosed techniques can be used to implement a sensor device. The sensor device includes an electromagnetic energy emitter module positioned to emit an electromagnetic energy beam directed to one or more objects within a first field of view, a beam steering module positioned to receive at least a portion of the electromagnetic energy beam that is reflected from the one or more objects within a second field of view, and an array of receiver units positioned to convert the portion of the electromagnetic energy beam into multiple electrical signals. The beam steering module is further positioned to direct the portion of the electromagnetic energy beam to the array of receiver units, with individual receiver units positioned to (1) detect multiple optical signals from the portion of the electromagnetic energy beam, the multiple optical signals being sequential in a time domain, and (2) convert the multiple optical signals into electrical signals.

In some embodiments, the electromagnetic energy emitter module comprises a holographic filter to diffract the electromagnetic energy beam in different directions. In some embodiments, the electromagnetic energy emitter module is positioned to generate multiple electromagnetic energy beams. The electromagnetic energy emitter module can include an array of diodes, an individual diode positioned to generate an electromagnetic energy beam. For example, the electromagnetic energy emitter module includes a Vertical Cavity Surface Emitting Laser (VCSEL) array or an edge-emitting diode array. In some implementations, electromagnetic energy emitter module comprises a collimator configured to collimate the electromagnetic energy beam.

In some embodiments, the beam steering module comprises an optical element that includes a first surface and a second, non-parallel surface, the first surface and the second surface forming an optical element angle. The optical element is positioned to rotate at an angular speed about an axis to direct the portion of the electromagnetic energy beam to the array of semiconductor units, with individual semiconductor units positioned to detect, along a closed path corresponding to the optical element angle, multiple optical signals from the portion of the electromagnetic energy beam. In some embodiments, the optical element includes a prism. In some implementations, the optical element angle is in a range from 0° to 50°. The angular speed can be slower than or equal to 12000 rpm.

In some embodiments, the beam steering module comprises a second optical element that includes a third surface and a fourth, non-parallel surface, the third surface and the fourth surface forming a second optical element angle. The second optical element is positioned to rotate at a second angular speed about the axis, and the first and second optical elements together direct the portion of the electromagnetic energy beam to the array of semiconductor units.

In some embodiments, e beam steering module comprises a scanning mirror supported by multiple elastic parts. The multiple elastic parts enable the scanning mirror to oscillate about one or more axes to direct the portion of the electromagnetic energy beam to the array of semiconductor units. In some embodiments, the scanning mirror has an oscillation range of 0 to 50 degrees with respect to the one or more axes.

In some embodiments, the beam steering module comprises a voltage source, and a phase control device that includes multiple units, wherein the individual units are connected to the voltage source to exhibit different refractive properties under different voltages to direct the portion of the electromagnetic energy beam to the array of semiconductor units.

In some embodiments, the individual receiver units include photodiodes. In some implementations, the array of receiver units is coupled to a substrate via a plurality of bonding units, with individual bonding units being positioned between a corresponding receiver unit and the substrate, and being separate from adjacent bonding units. In some implementations, the array of receiver units is coupled to a substrate via a bonding layer positioned between the array of receiver units and the substrate. In some embodiments, first field of view is larger than the second field of view.

In another representative aspect, the disclosed techniques can be used to implement a sensor device. The sensor device includes one or more laser diodes positioned to emit one or more laser beams, a collimator positioned to collimate the one or more laser beams toward one or more objects within a first field of view, a prism that includes two non-parallel surfaces forming a prism angle, the prism positioned to receive at least a portion of the one or more laser beams that is reflected back from the one or more objects within a second field of view, and an array of photodiodes configured to convert the portion of the one or more laser beams into multiple electrical signals. The prism is further positioned to rotate at an angular speed to direct the portion of the one or more laser beams to the array of photodiodes, with individual photodiodes positioned to (1) detect, along a closed path corresponding to the prism angle, multiple optical signals from the portion of the one or more laser beams, the multiple optical signals being sequential in a time domain, and (2) convert the multiple optical signals into electrical signals.

In another representative aspect, the disclosed techniques can be used to implement an autonomous system. The system includes a sensor that comprises an electromagnetic energy emitter module positioned to emit an electromagnetic energy beam directed to one or more objects within a first field of view, a beam steering module positioned to receive at least a portion of the electromagnetic energy beam that is reflected from the one or more objects within a second field of view, and an array of receiver units positioned to convert the portion of the electromagnetic energy beam into multiple electrical signals. The beam steering module is further positioned to direct the portion of the electromagnetic energy beam to the array of receiver units, with individual receiver units positioned to (1) detect multiple optical signals from the portion of the electromagnetic energy beam, the multiple optical signals being sequential in a time domain, and (2) convert the multiple optical signals into electrical signals. The autonomous system also includes a controller in communication with the sensor. The controller is configured to receive the multiple electrical signals from the sensor, construct, based on the multiple electrical signals, a model of the one or more objects, and transmit a signal for changing a position of the autonomous system based on the model of the one or more objects.

In some embodiments, the controller is configured to classify the multiple electrical signals into a plurality of groups, with an individual group corresponding to one of the one or more objects. In some embodiments, the system further comprises a motor in communication with the controller. The motor is configured to (1) receive the signal for changing the position of the autonomous system from the controller, and (2) supply a force to change the position of the autonomous system. In some embodiments, the system further comprises an autonomous vehicle carrying the sensor and the controller. The autonomous vehicle includes at least one of an autonomous aircraft, an autonomous automobile, or an autonomous robot.

In some embodiments, the electromagnetic energy emitter module comprises a holographic filter to diffract the electromagnetic energy beam in different directions. In some embodiments, the electromagnetic energy emitter module is positioned to generate multiple electromagnetic energy beams. The electromagnetic energy emitter module can include an array of diodes, an individual diode positioned to generate an electromagnetic energy beam. For example, the electromagnetic energy emitter module includes a Vertical Cavity Surface Emitting Laser (VCSEL) array or an edge-emitting diode array.

In some embodiments, the beam steering module comprises an optical element that includes a first surface and a second, non-parallel surface, the first surface and the second surface forming an optical element angle. The optical element is positioned to rotate at an angular speed about an axis to direct the portion of the electromagnetic energy beam to the array of semiconductor units, with individual semiconductor units positioned to detect, along a closed path corresponding to the optical element angle, multiple optical signals from the portion of the electromagnetic energy beam. In some implementations, the optical element includes a prism. In some embodiments, the optical element angle is in a range from 0° to 50°. The angular speed can be slower than or equal to 12000 rpm. In some embodiments, the beam steering module comprises a second optical element that includes a third surface and a fourth, non-parallel surface, the third surface and the fourth surface forming a second optical element angle. The second optical element is positioned to rotate at a second angular speed about the axis, and wherein the first and second optical elements together direct the portion of the electromagnetic energy beam to the array of semiconductor units.

In some embodiments, the beam steering module comprises a scanning mirror supported by multiple elastic parts. The multiple elastic parts enable the scanning mirror to oscillate about one or more axes to direct the portion of the electromagnetic energy beam to the array of semiconductor units. In some implementations, the scanning mirror has an oscillation range of 0 to 50 degrees with respect to the one or more axes.

In some embodiments, the beam steering module comprises a voltage source, and a phase control device that includes multiple units. The individual units are connected to the voltage source to exhibit different refractive properties under different voltages to direct the portion of the electromagnetic energy beam to the array of semiconductor units.

In some embodiments, the individual receiver units include photodiodes. In some implementations, the array of receiver units is coupled to a substrate via a plurality of bonding units, with individual bonding units being positioned between a corresponding receiver unit and the substrate, and being separate from adjacent bonding units. In some implementations, the array of receiver units is coupled to a substrate via a bonding layer positioned between the array of receiver units and the substrate. In some embodiments, the first field of view is larger than the second field of view.

In another representative aspect, the disclosed techniques can be used to implement a method for sensing one or more objects in an external environment. The method includes emitting an electromagnetic energy beam from an electromagnetic energy emitter module, operating a beam steering module to direct at least a portion of the electromagnetic energy beam that is reflected from the one or more objects in the external environment to an array of receiver units, detecting, via the array of receiver units, optical signals from the portion of the electromagnetic energy beam, wherein individual receiver units of the array of receiver units are positioned to detect multiple optical signals that are sequential in a time domain, and converting, via the array of receiver units, the optical signals into electrical signals.

In some embodiments, operating the beam steering module comprises rotating an optical element at an angular speed about an axis to direct the portion of the electromagnetic energy beam to the array of receiver units, the optical element including two surfaces forming an optical element angle. In some embodiments, rotating the optical element includes rotating the optical element at an angular speed that is slower than or equal to 12000 rpm. In some embodiments, operating the beam steering module further comprises rotating a second optical element at a second angular speed about the axis to direct the portion of the electromagnetic energy beam to the array of receiver units, the second optical element including two surfaces forming a second optical element angle.

In some embodiments, operating the beam steering module comprises oscillating a scanning mirror about one or more axes to direct the portion of the electromagnetic energy beam to the array of semiconductor units.

In some embodiments, operating the beam steering module comprises applying different voltages to different units of a phase control device such that the units exhibit different refractive properties to direct the portion of the electromagnetic energy beam to the array of semiconductor units.

In some embodiments, the method includes constructing, based on the electrical signals, a model of the one or more objects in the external environment. Constructing the model can include classifying the electrical signals into a plurality of groups, with an individual group corresponding to one of the one or more objects in the external environment.

The above and other aspects and their implementations are described in greater detail in the drawings, the description and the claims.

### BRIEF DESCRIPTION OF THE DRAWINGS

FIG. 1 is a schematic illustration of a representative system having elements in accordance with one or more embodiments of the present technology.

FIG. 2 illustrates some representative apparatus that can be used in various embodiments in accordance with one or more embodiments of the present technology.

FIG. 3 shows a schematic diagram of a representative LIDAR sensor system with a double-prism configuration.

FIG. 4A shows a schematic diagram of a representative sensor system configured in accordance with one or more embodiments of the present technology.

FIG. 4B shows another schematic diagram of the sensor system configured in accordance with one or more embodiments of the present technology.

FIG. 5A shows a schematic top view of a representative array of receiver units.

FIG. 5B shows a schematic side view of the representative array of receiver units corresponding to FIG. 5A.

FIG. 6A shows a schematic diagram of another representative array of receiver units.

FIG. 6B shows a schematic side view of the representative array of receiver units corresponding to FIG. 6A.

FIG. 7 shows a schematic diagram of representative light signals received by a 5×5 receiving array without the use of a rotating optical element.

FIG. 8 shows a schematic diagram of light signals received by a receiver unit with the use of a rotating optical element.

FIG. 9A shows a schematic diagram of light signals received by a 5×5 array of receiver units.

FIG. 9B shows a schematic diagram of light signals received by a 5×5 array of receiver units with a larger optical element angle.

FIG. 10A shows a representative configuration of the beam steering module configured in accordance with one or more embodiments of the present technology.

FIG. 10B shows a schematic diagram of light signals received by a 2×3 array of receiver units.

FIG. 11A shows a representative scanning mirror configured in accordance with one or more embodiments of the present technology.

FIG. 11B shows a schematic diagram of light signals received by a 3×3 array of receiver units from a scanning mirror.

FIG. 11C shows another schematic diagram of light signals received by a 3×3 array of receiver units from a scanning mirror.

FIG. 12 shows a representative phase control device configured in accordance with one or more embodiments of the present technology.

FIG. 13 is a flowchart representation of a method for sensing one or more objects in an external environment.

FIG. 14 is a block diagram illustrating a representative example of the architecture for a computer system or other control device that can be utilized to implement various portions of the presently disclosed technology.

FIG. 15 shows a schematic diagram of a receiver array in accordance with one or more embodiments of the present technology.

### DETAILED DESCRIPTION

As introduced above, it is important for intelligent machinery to be able to independently detect obstacles and/or to automatically engage in evasive maneuvers. Light detection and ranging (LIDAR) is a reliable and accurate detection technology. Moreover, unlike traditional image sensors (e.g., cameras) that can only sense the surroundings in two dimensions, LIDAR can obtain three-dimensional information by detecting depth or distance to an object. However, current LIDAR systems have limitations. For example, to ensure the amount of data collected from the external environment is adequate, it is desirable to operate the light emitting module (e.g., a laser diode) at a frequency of more than 1,000 pulses per second. To accommodate such a high frequency, the complexity and cost of the corresponding optical and electrical modules can be very high. Accordingly, there remains a need for improved techniques for implementing LIDAR systems to achieve lower manufacturing cost while maintaining a suitable amount of input data.

In the following discussion, numerous specific details are set forth to provide a thorough understanding of the presently disclosed technology. In other embodiments, the techniques introduced here can be practiced without these specific details. In other instances, well-known features, such as specific fabrication techniques, are not described in detail in order to avoid unnecessarily obscuring the present disclosure. References in this description to “an embodiment,” “one embodiment,” or the like, mean that a particular feature, structure, material, or characteristic being described is included in at least one embodiment of the present disclosure. Thus, the appearances of such phrases in this specification do not necessarily all refer to the same embodiment. On the other hand, such references are not necessarily mutually exclusive either. Furthermore, the particular features, structures, materials, or characteristics can be combined in any suitable manner in one or more embodiments. Also, it is to be understood that the various embodiments shown in the figures are merely illustrative representations and are not necessarily drawn to scale.

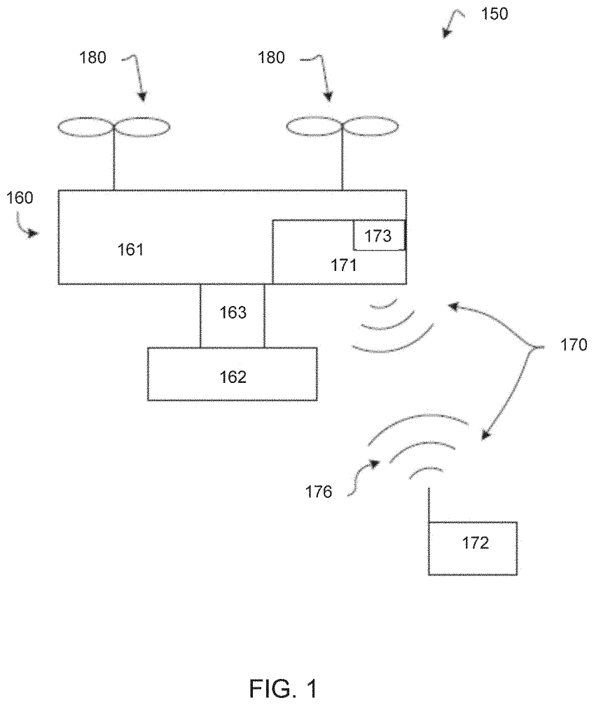

FIG. 1 is a schematic illustration of a representative system 150 having elements in accordance with one or more embodiments of the present technology. The system 150 includes an apparatus 160 (e.g., an unmanned aerial vehicle) and a control system 170.

The apparatus 160 can include a main body 161 (e.g., an airframe) that can carry a payload 162, for example, an imaging device or an optoelectronic scanning device (e.g., a LIDAR device). In some embodiments, the payload 162 can be a camera, a video camera and/or still camera. The camera can be sensitive to wavelengths in any of a variety of suitable bands, including visual, ultraviolet, infrared and/or other bands. The payload 162 can also include other types of sensors and/or other types of cargo (e.g., packages or other deliverables). In some embodiments, the payload 162 is supported relative to the main body 161 with a carrying mechanism 163. The carrying mechanism 163 can allow the payload 162 to be independently positioned relative to the main body 161. For instance, the carrying mechanism 163 can permit the payload 162 to rotate around one, two, three, or more axes. The carrying mechanism 163 can also permit the payload 162 to move linearly along one, two, three, or more axes. The axes for the rotational or translational movement may or may not be orthogonal to each other. In this way, when the payload 162 includes an imaging device, the imaging device can be moved relative to the main body 161 to photograph, video or track a target.

In some embodiments, the apparatus 160 may include one or more propulsion units 180. The one or more propulsion units 180 can enable the apparatus 160 to move, e.g., to take off, land, hover, and move in the air with respect to up to three degrees of freedom of translation and up to three degrees of freedom of rotation. In some embodiments, the propulsion units 180 can include one or more rotors. The rotors can include one or more rotor blades coupled to a shaft. The rotor blades and shaft can be rotated by a suitable drive mechanism, such as a motor. Although the propulsion units 180 of the apparatus 160 are depicted as propeller-based and can have four rotors, any suitable number, type, and/or arrangement of propulsion units can be used. For example, the number of rotors can be one, two, three, four, five, or more. The rotors can be oriented vertically, horizontally, or at any other suitable angle with respect to the apparatus 160. The angle of the rotors can be fixed or variable. The propulsion units 180 can be driven by any suitable motor, such as a DC motor (e.g., brushed or brushless) or an AC motor. In some embodiments, the motor can be configured to mount and drive a rotor blade.

The apparatus 160 is configured to receive control commands from the control system 170. In the embodiment shown in FIG. 1, the control system 170 includes some components carried on the apparatus 160 and some components positioned off the apparatus 160. For example, the control system 170 can include a first controller 171 carried by the apparatus 160 and a second controller 172 (e.g., a human-operated, remote controller) positioned remotely from the apparatus 160 and connected via a communication link 176 (e.g., a wireless link such as a radio frequency (RF) based link). The first controller 171 can include a computer-readable medium 173 that executes instructions directing the actions of the apparatus 160, including, but not limited to, operation of the propulsion system 180 and the payload 162 (e.g., a camera). The second controller 172 can include one or more input/output devices, e.g., a display and control buttons. The operator manipulates the second controller 172 to control the apparatus 160 remotely, and receives feedback from the apparatus 160 via the display and/or other interfaces on the second controller 172. In other representative embodiments, the apparatus 160 can operate autonomously, in which case the second controller 172 can be eliminated, or can be used solely for operator override functions.

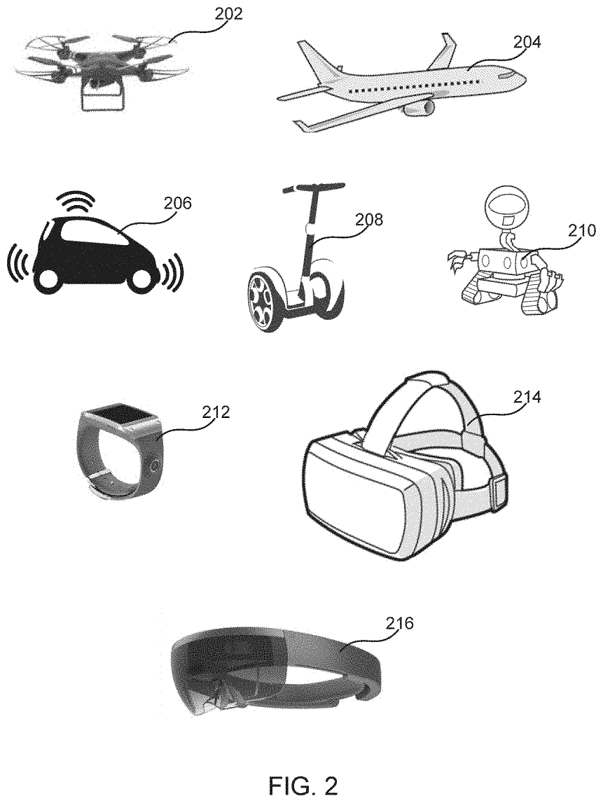

The apparatus 160 can be any suitable types of devices that can be used in various embodiments. FIG. 2 demonstrates some representative devices including at least one of an unmanned aerial vehicle (UAV) 202, a manned aircraft 204, an autonomous car 206, a self-balancing vehicle 208, a terrestrial robot 210, a smart wearable device 212, a virtual reality (VR) head-mounted display 214, and an augmented reality (AR) head-mounted display 216.

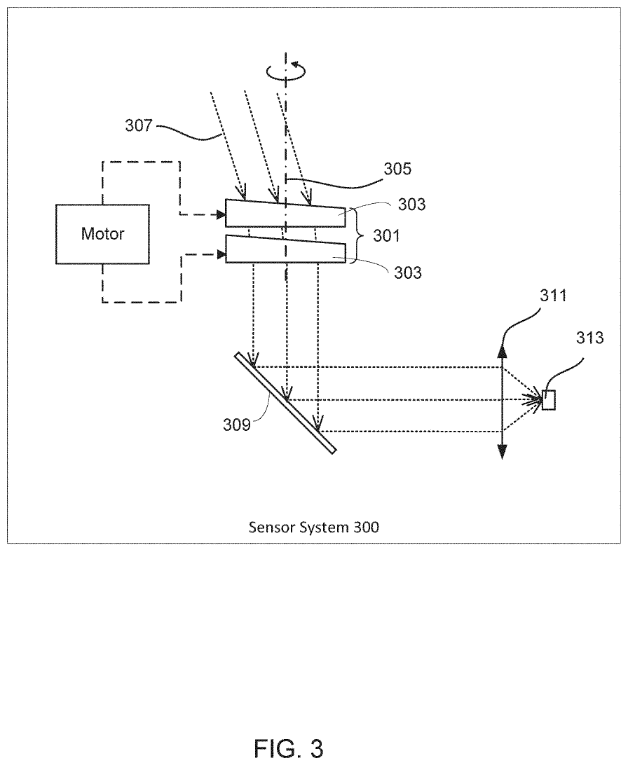

FIG. 3 illustrates some general aspects in which a current LIDAR system operates. The LIDAR sensor system 300 shown in FIG. 3 includes a double-prism beam steering device 301. The two prisms 303 can rotate about a common axis 305 in order to steer the light in different directions. The return beam 307 is steered by the beam steering device 301 and reflected by a beam splitting device 309 toward a receiving lens 311, which can collect and focus the returned beam on a detector 313.

In the configuration shown in FIG. 3, in order to provide suitable coverage of the environment via the sensor system 300, and appropriate density of the point cloud data for the corresponding objects, it is desirable to rotate the two prisms in the beam steering device 301 at a high speed (e.g., over 5000 revolutions per second). However, a high rotational speed may lead to high power consumption for the sensor system—cooling the sensor system may also become a concern.

Alternatively, instead of using a beam steering device 301 to direct light in different directions, the detector can include a solid-state type of configuration using a large number of receiving elements (e.g., an array of receiving elements) to increase the density of the electrical signals received by the controller. However, a large array of receiving elements (e.g., over 100×100 elements) also raise concerns regarding area and power consumption in circuitry design.

Embodiments of the present technology include a different sensor system that combines certain advantages of the rotating prism and the array of receiving elements. Using the disclosed techniques, the complexity of calibrating two rotating prisms can be eliminated, thereby reducing the manufacturing complexity of the sensor system. With the use of a small array of receiving elements, the rotational speed of the prism can also be greatly reduced, reducing power consumption of the sensor system.

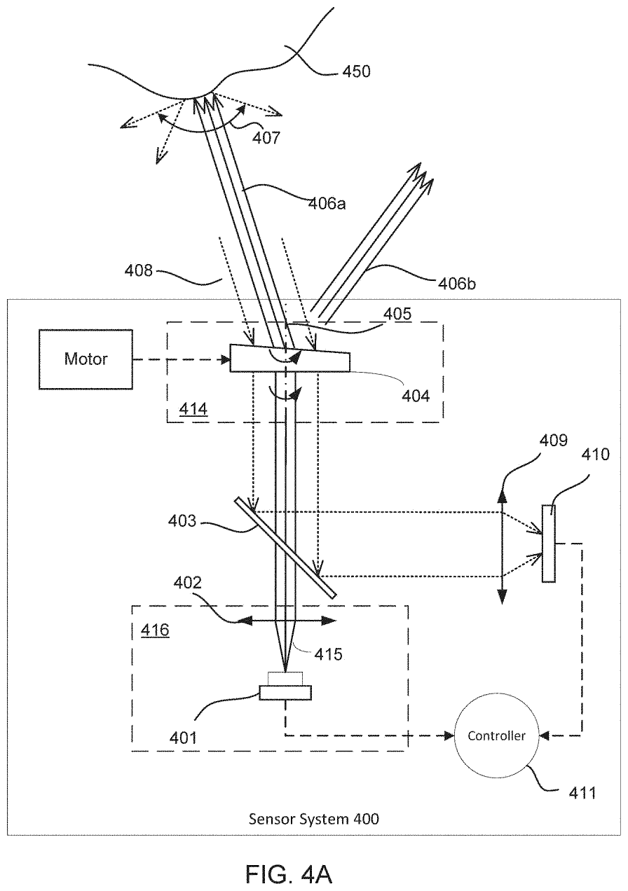

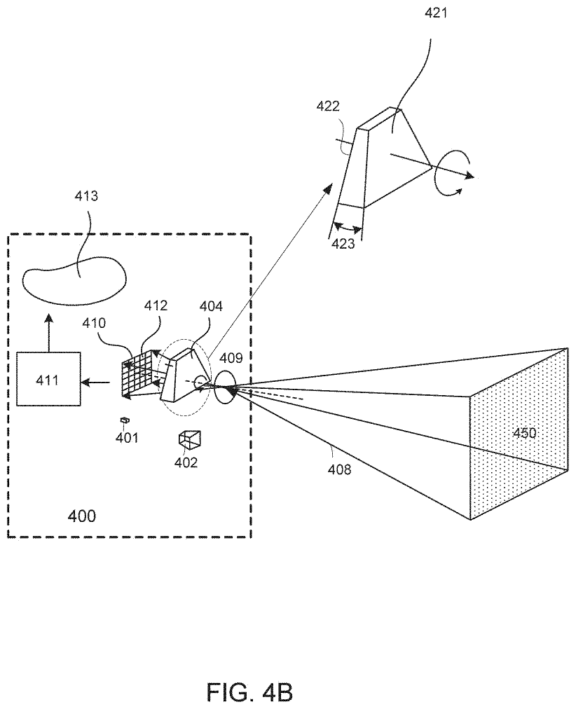

FIG. 4A shows a schematic diagram of a representative sensor system 400 configured in accordance with one or more embodiments of the present technology. The sensor system 400 can detect the distance of an object 450 in the external environment based on measuring the time for light to travel between the sensor system 400 and the object 450, i.e., the time-of-flight (TOF). The sensor system 400 includes an emitter module 416. The emitter module 416 includes an emitter 401 (e.g., a laser diode) that can generate an electromagnetic energy beam 415, such as a laser beam, within a first field of view (FOV) of the emitter 401. The electromagnetic energy beam 415 can be a single electromagnetic energy pulse or a series of electromagnetic energy pulses. In the discussion below, a light emitter is used as an example. It is however noted that any suitable types of electromagnetic energy emitters can be adopted in the sensor system 400.

The emitter module 416 may include a collimator 402 (e.g., a lens) that can be used for collimating the light beam 415 generated by the light emitter 401. In some embodiments, the collimated light can be directed toward a beam splitting device 403. The beam splitting device 403 can allow the collimated light from the emitter module 416 to pass through. Alternatively, the beam splitting device 403 may not be necessary when different schemes are employed (e.g., when a light emitter is positioned in front of the detector).

The sensor system 400 may also include a beam steering module 414 that includes an optical element 404. The optical element 404 can rotate about an axis 405 in order to steer the light in different directions, such as a first direction 406a and a second direction 406b. When the outgoing beam in the first direction 406a hits the object 450, the reflected or scattered light may spread over a large angle 407 and only a fraction of the energy may be reflected back toward the sensor system 400. The return beam 408 can be reflected by the beam splitting device 403 toward a receiving lens 409, which can collect and focus the returned beam on a detector 410 that includes an array of receiving elements. The detector 410 operates with a second FOV, which can be the same as or smaller than the first FOV of the emitter 401.

FIG. 4B shows another schematic diagram of the LIDAR sensor system 400. When the outgoing beam hits the object 450, the return beam 408 can be reflected toward a receiving lens 409, which can collect and focus the returned beam on an optical element 404 (e.g., a prism). In this example, the optical element 404 includes a first surface 421 and a second surface 422. The first and second surfaces 421, 422 are non-parallel, forming an optical element angle 423. The optical element angle 423 allows the optical element 404 to steer the returned beam in different directions toward the detector 410. The detector 410 includes a small array of receiver units 412. The optical element angle 423 can be in a range from 0° to 50°, and can have other suitable values in other embodiments. In some implementations, the optical element angle 423 is in a range from 5° to 15°. The detector 410 receives the returned light beam and converts the light beam into electrical signals. In some implementations, to allow more receiver units 412 to receive light, it is desirable for the emitter 401 to have a larger first FOV than the second FOV of the detector 410.

The detector 410 receives the returned light and converts the light into electrical signals. As shown in both FIGS. 4A-4B, a controller 411 can be coupled to the detector 410 (which includes the array of receiver units 412) for measuring the TOF to detect the distance to the object 450. For example, the controller 411 can create a corresponding point cloud data set for the object 450 based on the electrical signals from the detector 410. Thus, the sensor system 400 can measure the distance to the object 450 based on the time difference between generating the pulse by the emitter 401 and receiving the return beam 408 by the detector 410.

In some implementations, the emitter module 416 includes a holographic filter. The holographic filter can diffract an incoming light beam into different directions. For example, a holographic bandpass filter that has a shape of a cube can be placed between the emitter 401 and the collimator 402 to diffract the light beam from the emitter 401 at angles between 0° to 90°.

In some embodiments, the light emitter 401 can generate multiple light beams. For example, the emitter 401 can include an array of diodes, each generating a light beam that can be received by a corresponding receiver unit. For example, the emitter 401 can include a Vertical Cavity Surface Emitting Laser (VCSEL) array or an edge-emitting diode array. As another example, multiple edge-emitting laser diodes can be packaged together to form a packaged emitter.

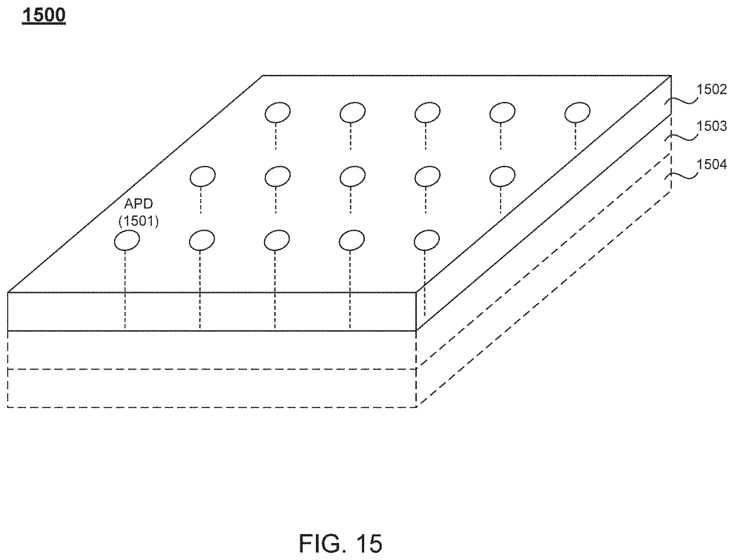

In some embodiments, each receiver unit 412 of the array comprises a photodiode to convert light signals into electrical signals. FIG. 15 shows a schematic diagram of a receiver array 1500 in accordance with one or more embodiments of the present technology. As shown in FIG. 15, the array 1500 includes a plurality of Avalanche Photodiode (APD) units (1501). The array can include a detection layer 1502 coupled to the plurality of APD units for signal detection and collection. Optionally, the array can include an analog layer 1503 coupled to the detection layer 1502 to perform signal amplification. In some implementations, the array includes a logical layer 1504 to perform signal processing, such as time-to-digital conversion, analog-to-digital conversion, and various algorithms including denoising. In some embodiments, the array can be implemented as a Photodiode (PD) array or a PIN (Positive-Intrinsic-Negative) PD array.

In some implementations, a small array can be used to reduce manufacturing cost. For example, a 10×10 array can be used to receive the light beam and convert optical signals to electrical signals. In some implementations, a large array can be used to obtain higher density of the data. For example, an array of 8K resolution (i.e., 7680×4320 pixels) can be used in some configurations.

When the light emitter 401 includes an array of diodes, the individual diodes are positioned to obtain an optical correspondence with the receiver units 412 in the detector 410. The beam steering module 414 can also be used to simultaneously vary the angles of the light beams from the diodes and the angles of light beams to the receivers to obtain the correspondence between the diodes and receiver units.

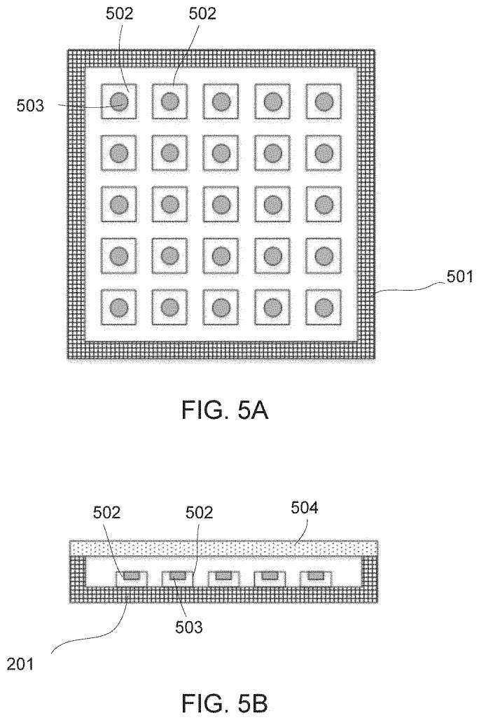

FIG. 5A shows a schematic top view of a representative array of receiver units 500. In this particular embodiment, each separate unit 503 is disposed on or in a separate die 502. The individual dies are coupled to the substrate 501 separately using methods such as die bonding techniques. FIG. 5B shows a schematic side view of the representative array of receiver units 500. A protecting plate 504, such as a glass plate, can be coupled to the substrate 501 to allow the light to pass through while protecting the units from external hazards.

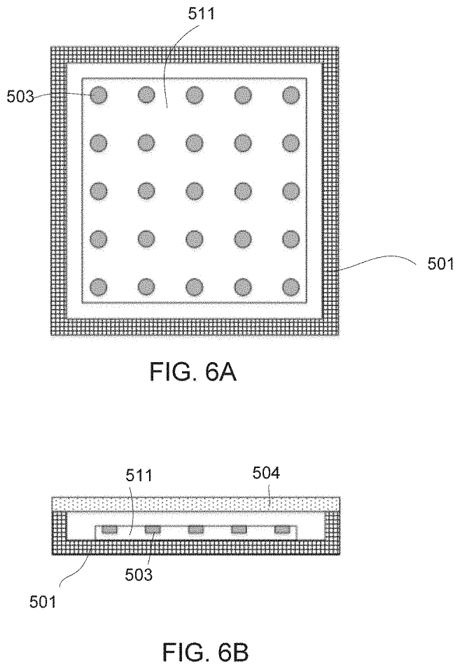

FIG. 6A shows a schematic diagram of another representative array of receiver units 600. In this particular embodiment, the receiver units are disposed in a uniform die 511 that functions as a bonding layer. The die 511 is then coupled to the substrate 501 using methods such as die bonding techniques. FIG. 6B shows a schematic side view of the representative array of receiver units 600. Similarly, a protecting plate 504, such as a glass plate, can be coupled to the substrate 501 to allow the light to pass through while protecting the units from external hazards.

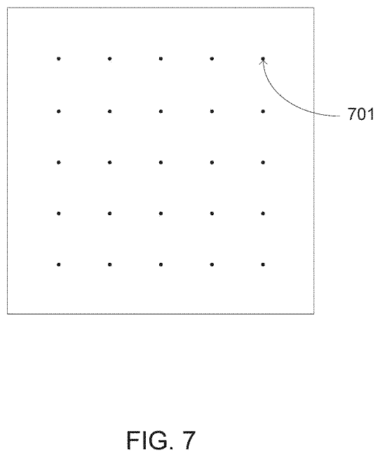

Without the rotating optical element shown in FIGS. 4A-4B, each receiver unit on the array may detect only one light signal. FIG. 7 shows a schematic diagram of representative light signals received by a 5×5 receiving array without the use of an optical element. In this example, each of the semiconductor element of the array receives a single light signal 701 over a period T (e.g., 1 ms).

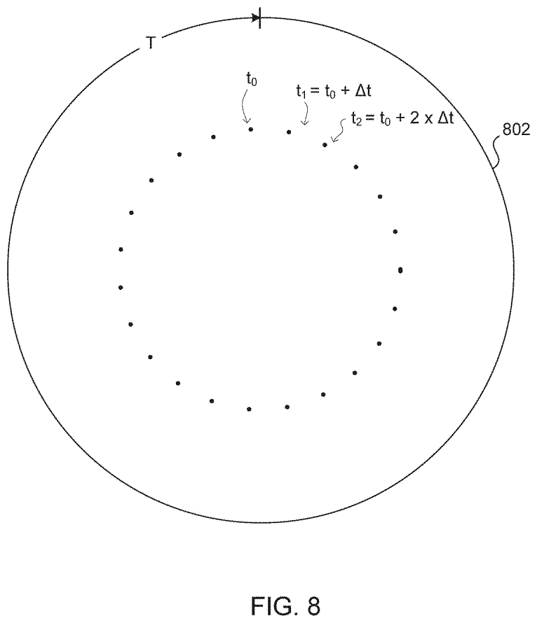

When the optical element is rotated, however, each receiver unit can receive multiple light signals. The light emitter usually has a high operating frequency, while the frequency at which the receiver units operate may be relatively low. Accordingly, when the optical element rotates, individual semiconductor elements can leverage the high operating frequency of the light emitter and receive multiple light signals that are sequential in the time domain. FIG. 8 shows a schematic diagram of light signals received by a receiver unit of an array when the optical element rotates. In this example, the optical element can complete a full rotation in the period T, and the frequency of the light beam pulses is f=1/Δt. Therefore, the receiver unit can receive multiple light signals, e.g., one at each of times t0, t1=t0+Δt, t2=t0+2×Δt, etc. along a closed path within a period T, forming a closed path 802. For example, the operating frequency of the light emitter can be 1 MHz (Δt=1 μs). The optical element can rotate at a speed of 1000 revolutions per second (rev/s). The rotation of the optical element allows the receiver units to capture all the light signals within the period T=1 millisecond at different locations (1000 signals per millisecond). In some implementations, the optical element can rotate at a lower angular speed, e.g., 200 rev/s (equal to 12000 rpm) or lower. For example, the optical element rotates at 200 rev/s and takes T=5 milliseconds to complete a full rotation. The optical element can thus capture all the light signals within the 5 milliseconds at different locations. The use of time-domain data thus can compensate for the spatial sparsity of the point cloud data and increase the density of data for the controller to more accurately model the external environment. Using the time-domain data also allows the optical element to rotate at a much lower angular speed, thereby consuming less power and providing more stability.

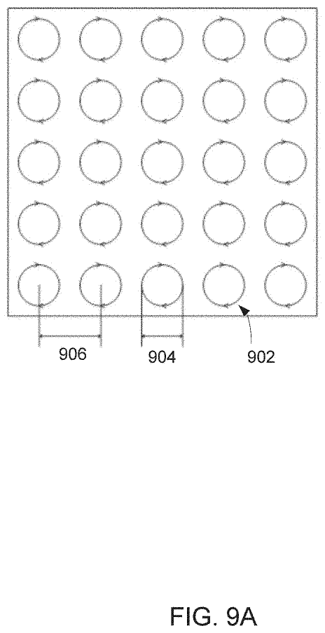

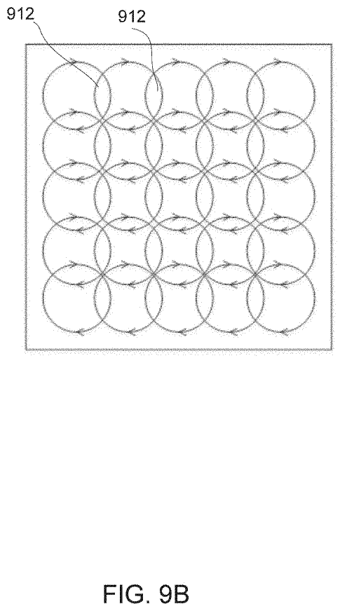

FIG. 9A shows a schematic diagram of light signals received by a 5×5 array of receiver units. Each unit receives multiple signals that are sequential in the time domain, forming a closed path 902. In this embodiment, the closed path 902 is a circle. In particular, the diameter of the circle 904 can be determined based on the optical element angle. For example, a larger optical element angle can result in a larger diameter of the circles. The distance 906 between the centers of two closed paths is determined based on the placement of adjacent receiver units of array.

In the example shown in FIG. 9A, the optical element angle is small so that there is no overlap between adjacent circles. However, this may create some areas that are not covered by any of the light beams (also known as “blind areas”). Thus, in some implementations, it is desirable to have overlapping areas between adjacent closed paths so that blind areas are reduced (e.g., minimized). FIG. 9B shows a schematic diagram of light signals received by a 5×5 array of receiver units with a larger optical element angle. In this embodiment, the optical element angle is larger, resulting in overlapping areas 912 between the adjacent circles. It is noted, however, because the signals are received sequentially in the time domain, two signals do not appear at the same location at the same time along the paths.

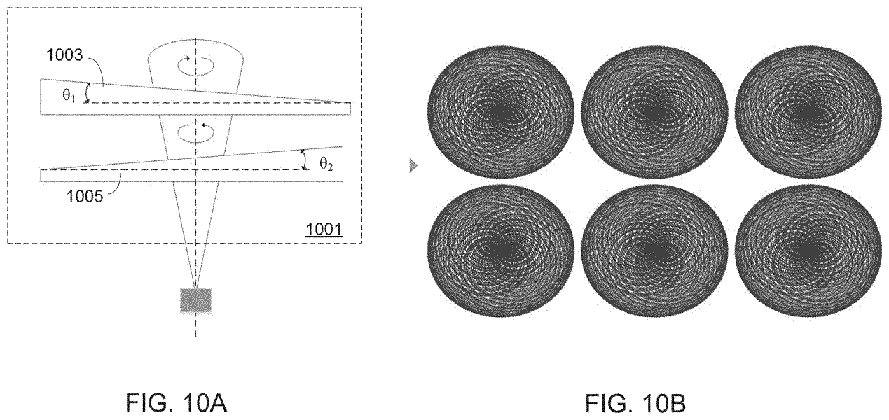

In some embodiments, the beam steering module shown in FIG. 4A includes a second optical element to allow the receiver units to obtain a denser collection of data. FIG. 10A shows a representative configuration of the beam steering module 1001. The beam steering module 1001 includes a first optical element 1003 having a first optical angle θ₁ and a second optical element 1005 having a second optical angle θ₂. Both optical element 1003, 1005 rotate about a common axis. FIG. 10B shows a schematic diagram of light signals received by a 2×3 array of receiver units. Using two optical elements can greatly increase the density of the signals.

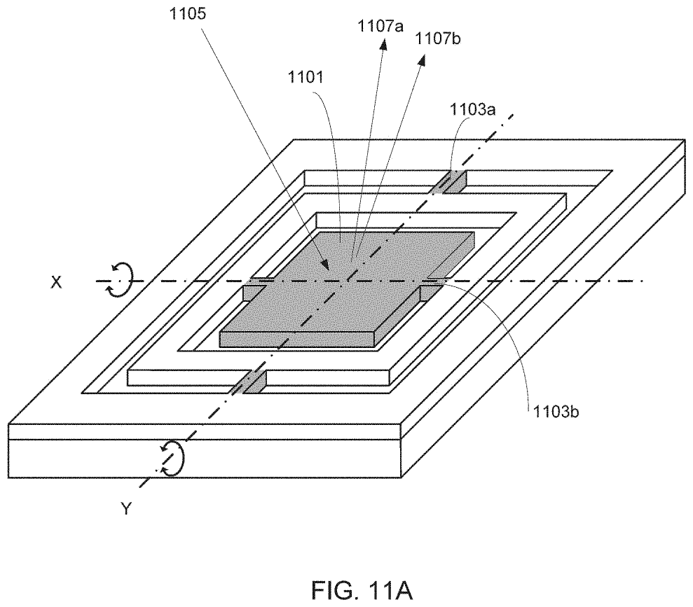

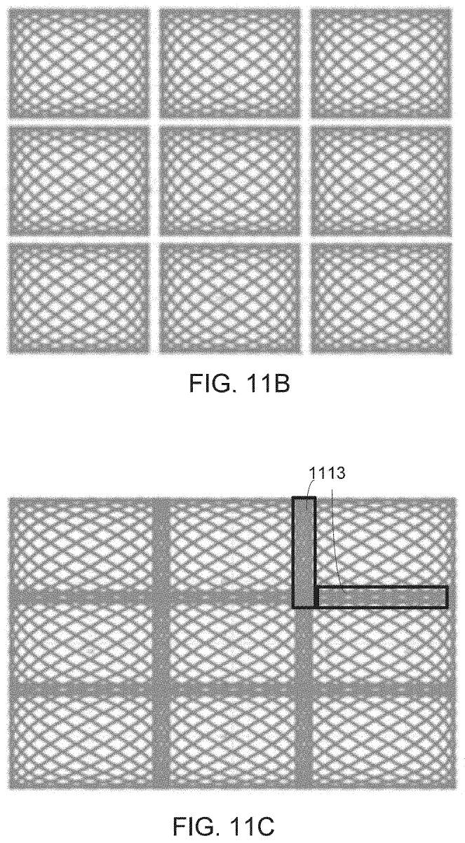

The beam steering module can also use alternative optical configurations to steer the returned beams in different directions so that each receiver unit receives multiple light signals within a time period. In some embodiments, the beam steering module can include a scanning mirror, such as a Micro Electro Mechanical System (MEMS) scanning mirror, to generate multiple light signals in different directions. FIG. 11A shows a representative scanning mirror configured in accordance with one or more embodiments of the present technology. The mirror 1101 is supported by elastic parts 1103a, 1103b so that the mirror 1101 can oscillate around both the X axis and Y axis. In some embodiments, the mirror 1101 oscillates within a range of [0°, 20°] with respect to the two axes. In some implementations, the mirror 1101 oscillates within a much wider range, e.g., within a range of [0°, 50°] with respect to the two axes, to provide a wider range of light beams. By adjusting the frequency of oscillations around one or both axes, the mirror 1101 can reflect the incoming beam 1105 into different directions 1107a, 1107b. The receiver units then can receive multiple signals that are sequential in the time domain.

FIG. 11B shows a schematic diagram of light signals received by a 3×3 array of receiver units from a scanning mirror. In this example, the scanning mirror has a small oscillation range, resulting a small angular range of reflected beams. The FOV angle of the receiver units, however, is larger than the angular range of the reflected beams. Therefore, there are no overlapping areas for the received signals.

FIG. 11C shows another schematic diagram of light signals received by a 3×3 array of receiver units from a scanning mirror. In this example, the scanning mirror has a large oscillation range, resulting a large angular range of reflected beams. The FOV angle of the receiver units is thus smaller than the angular range of the reflected beams. Therefore, adjacent receiver units can detect overlapping areas 1113 in the received signals.

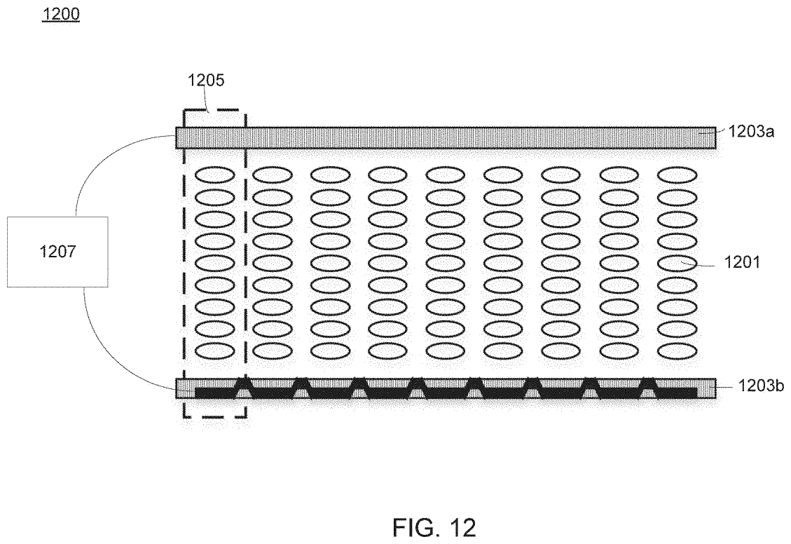

In some embodiments, the beam steering module can include a phase control device to generate multiple light signals in different directions. FIG. 12 shows a representative phase control device 1200 configured in accordance with one or more embodiments of the present technology. The device includes a liquid crystal layer 1201 placed between two transparent electrodes 1203a, 1203b. The device is divided into individual units 1205 to allow independent control of each unit. When the individual units are connected to a voltage source 1207, the liquid crystal molecules rotate, thereby changing the refractive indices of individual units. By applying different voltages to different units, different refractive indices allow the light to be refracted in different directions. Other phase control devices, such as optical waveguide phase control devices, can also be used to generate multiple light beams in different direction to allow the receiver units to obtain a denser collection of data.

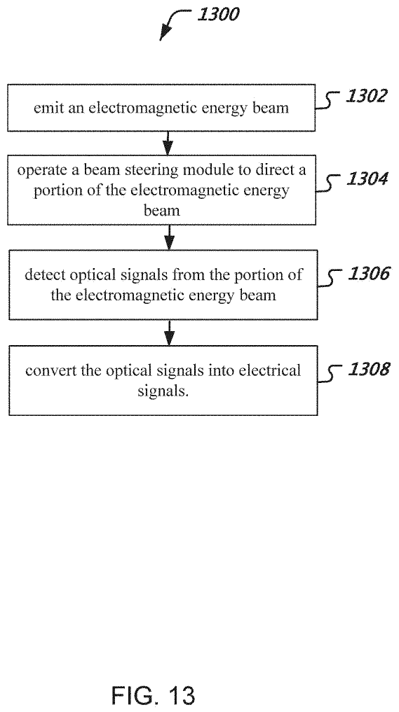

FIG. 13 is a flowchart representation of a method for sensing one or more objects in an external environment. The method 1300 includes, at block 1302, emitting an electromagnetic energy beam from an electromagnetic energy emitter. The method 1300 includes, at block 1304, operating a beam steering module to direct at least a portion of the electromagnetic energy beam that is reflected from the one or more objects in the external environment to an array of receiver units. The method includes, at block 1306, detecting, via the array of receiver units, optical signals from the portion of the electromagnetic energy beam, wherein individual receiver units of the array of receiver units are positioned to detect multiple optical signals that are sequential in a time domain. The method also includes, at block 1308, converting, via the array of receiver units, the optical signals into electrical signals.

In some embodiments, operating the beam steering module includes rotating an optical element at an angular speed about an axis to direct the portion of the electromagnetic energy beam to the array of receiver units, the optical element including two surfaces forming an optical element angle. In some implementations, rotating the optical element includes rotating the optical element at an angular speed between 500 to 1000 rev/s. In some embodiments, operating the beam steering module further comprises rotating a second optical element at a second angular speed about the axis to direct the portion of the electromagnetic energy beam to the array of receiver units, the second optical element including two surfaces forming a second optical element angle.

In some embodiments, operating the beam steering module includes oscillating a scanning mirror about one or more axes to direct the portion of the electromagnetic energy beam to the array of semiconductor units. In some embodiments, operating the beam steering module includes applying different voltages to different units of a phase control device such that the units exhibit different refractive properties to direct the portion of the electromagnetic energy beam to the array of semiconductor units.

In some embodiments, representative methods include constructing, based on the electrical signals, a model of the one or more objects in the external environment. In some implementations, constructing the model comprises classifying the electrical signals into a plurality of groups, with an individual group corresponding to one of the one or more objects in the external environment.

In one advantageous aspect, the disclosed techniques can reduce the complexity of manufacturing the sensor system. Because a single optical element can be used, as compared to multiple ones in other configurations, the calibration of the sensor system can be simplified. The array of receiver units has a small size, thereby reducing area cost and power consumption as compared to other solid-state configurations in the detector.

In another advantageous aspect, the combination of the single optical element with the small array of receiver units allows the sensor system to provide a sufficient coverage of the environment and an appropriate density of the point cloud data for modeling the environment. Due to the use of the array, the rotational speed of the optical element can be reduced to 500 to 1000 rev/s as compared to over 5000 rev/s in other configurations. A lower rotational speed can greatly reduce power consumption of the sensor system and also lead to a longer service life of the product.

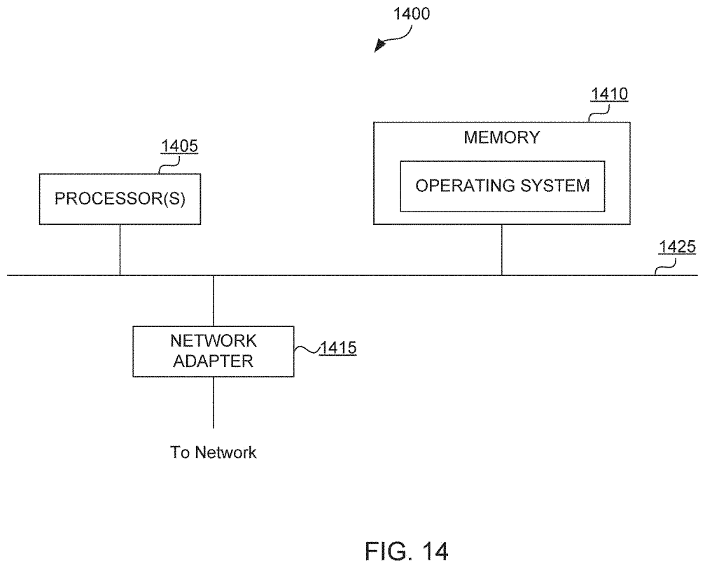

FIG. 14 is a block diagram illustrating an example of the architecture for a computer system or other control device 1400 that can be utilized to implement various portions of the presently disclosed technology. In FIG. 14, the computer system 1400 includes one or more processors 1405 and memories 1410 connected via an interconnect 1425. The interconnect 1425 may represent any one or more separate physical buses, point to point connections, or both, connected by appropriate bridges, adapters, or controllers. The interconnect 1425, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 674 bus, sometimes referred to as “Firewire.”

The processor(s) 1405 may include central processing units (CPUs) to control the overall operation of, for example, the host computer. In certain embodiments, the processor(s) 1405 accomplish this by executing software or firmware stored in memory 1410. The processor(s) 1405 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 1410 can be or include the main memory of the computer system. The memory 1410 represents any suitable form of random access memory (RAM), read-only memory (ROM), flash memory, or the like, or a combination of such devices. In use, the memory 1410 may contain, among other things, a set of machine instructions which, when executed by the processor 1405, causes the processor 1405 to perform operations to implement embodiments of the presently disclosed technology.

Also connected to the processor(s) 1405 through the interconnect 1425 is an (optional) network adapter 1415. The network adapter 1415 provides the computer system 1400 with the ability to communicate with remote devices, such as the storage clients, and/or other storage servers, and may be, for example, an Ethernet adapter or Fiber Channel adapter.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While the present disclosure contains many specifics, these should not be construed as limitations on the scope of any invention or of what may be claimed, but rather as descriptions of features that may be specific to particular embodiments. Certain features that are described in this patent document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this document should not be understood as requiring such separation in all embodiments.

Only a number of implementations and examples are described and other implementations, enhancements and variations can be made based on what is described and illustrated in this document.

From the foregoing, it will be appreciated that specific embodiments of the disclosed technology have been described herein for purposes of illustration, but that various modifications may be made without deviating from the technology. For example, while a light emitter is used as an example in the foregoing discussion, any suitable type of electromagnetic emitter can be used for various sensor systems. Certain aspects of the technology described in the context of particular embodiments may be combined or eliminated in other embodiments. Further, while advantages associated with certain embodiments of the disclosed technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A sensor device, comprising:
an electromagnetic energy emitter module configured to emit an electromagnetic energy beam directed to one or more objects within a first field of view;
a beam steering module configured to receive at least a portion of a reflected electromagnetic energy beam that is reflected from the one or more objects within a second field of view; and
an array of receiver units configured to convert the portion of the reflected electromagnetic energy beam into multiple electrical signals,
wherein the beam steering module is further configured to direct the portion of the reflected electromagnetic energy beam to the array of receiver units; and
wherein each receiver unit in the array of receiver units is configured to:
detect multiple optical signals from the portion of the reflected electromagnetic energy beam, the multiple optical signals being sequential in a time domain, and
convert the multiple optical signals into electrical signals.

2. The sensor device of claim 1, wherein the electromagnetic energy emitter module comprises a holographic filter configured to diffract the electromagnetic energy beam in different directions.

3. The sensor device of claim 1, wherein the electromagnetic energy emitter module is configured to generate multiple electromagnetic energy beams.

4. The sensor device of claim 3, wherein the electromagnetic energy emitter module comprises an array of diodes, wherein each diode in the array of diodes is configured to generate the multiple electromagnetic energy beams.

5. The sensor device of claim 4, wherein the electromagnetic energy emitter module comprises a Vertical Cavity Surface Emitting Laser (VCSEL) array or an edge-emitting diode array.

6. The sensor device of claim 1, wherein the electromagnetic energy emitter module comprises a collimator configured to collimate the electromagnetic energy beam.

7. The sensor device of claim 1, wherein the beam steering module comprises:
an optical element comprising a first surface and a second surface, the first surface and the second surface forming an optical element angle,
wherein the optical element is configured to rotate at an angular speed about an axis to direct the portion of the reflected electromagnetic energy beam to the array of semiconductor units, with individual semiconductor units configured to detect, along a closed path corresponding to the optical element angle, multiple optical signals from the portion of the reflected electromagnetic energy beam.

8. The sensor device of claim 7, wherein the optical element includes a prism.

9. (canceled)

10. (canceled)

11. The sensor device of claim 7, wherein the beam steering module further comprises:
a second optical element that includes a third surface and a fourth surface, the third surface and the fourth surface forming a second optical element angle,
wherein the second optical element is configured to rotate at a second angular speed about the axis, and wherein the first and second optical elements together direct the portion of the reflected electromagnetic energy beam to the array of semiconductor units.

12. The sensor device of claim 1, wherein the beam steering module comprises:
a scanning mirror supported by multiple elastic parts, wherein the multiple elastic parts enable the scanning mirror to oscillate about one or more axes to direct the portion of the reflected electromagnetic energy beam to the array of semiconductor units.

13. The sensor device of claim 12, wherein the scanning mirror has an oscillation range of 0 to 50 degrees with respect to the one or more axes.

14. The sensor device of claim 1, wherein the beam steering module comprises:
a voltage source, and
a phase control device comprising multiple units, wherein the individual units are connected to the voltage source to exhibit different refractive properties under different voltages to direct the portion of the reflected electromagnetic energy beam to the array of semiconductor units.

15. (canceled)

16. The sensor device of claim 1, wherein the array of receiver units is coupled to a substrate via a plurality of bonding units, wherein each bonding unit in the plurality of bonding units is positioned between a corresponding receiver unit and the substrate and separated from adjacent bonding units.

17. The sensor device of claim 1, wherein the array of receiver units is coupled to a substrate via a bonding layer positioned between the array of receiver units and the substrate.

18. (canceled)

19. A sensor device, comprising:
one or more laser diodes positioned to emit one or more laser beams;
a collimator positioned to collimate the one or more laser beams toward one or more objects within a first field of view;
a prism that includes two non-parallel surfaces forming a prism angle, the prism configured to receive at least a portion of one or more reflected laser beams that are reflected back from the one or more objects within a second field of view; and
an array of photodiodes configured to convert the portion of the one or more reflected laser beams into multiple electrical signals,
wherein the prism is further configured to rotate at an angular speed to direct the portion of the one or more reflected laser beams to the array of photodiodes; and
wherein each photodiode in the array of photodiodes is configured to:
detect, along a closed path corresponding to the prism angle, multiple optical signals from the portion of the one or more reflected laser beams, the multiple optical signals being sequential in a time domain, and
convert the multiple optical signals into electrical signals.

20. An autonomous system, comprising:
a sensor that comprises:
an electromagnetic energy emitter module configured to emit an electromagnetic energy beam directed to one or more objects within a first field of view;
a beam steering module configured to receive at least a portion of a received electromagnetic energy beam that is reflected from the one or more objects within a second field of view; and
an array of receiver units configured to convert the portion of the received electromagnetic energy beam into multiple electrical signals,
wherein the beam steering module is further configured to direct the portion of the received electromagnetic energy beam to the array of receiver units; and
wherein each receiver unit in the array of receiver units is configured to:
detect multiple optical signals from the portion of the received electromagnetic energy beam, the multiple optical signals being sequential in a time domain, and
convert the multiple optical signals into electrical signals,
a controller in communication with the sensor, the controller configured to:
receive the multiple electrical signals from the sensor;
construct, based on the multiple electrical signals, a model of the one or more objects; and
transmit a signal for changing a position of the autonomous system based on the model of the one or more objects.

21. The autonomous system of claim 20, wherein the controller is configured to classify the multiple electrical signals into a plurality of groups, wherein each group in the plurality of groups corresponds to one of the one or more objects.

22. The autonomous system of claim 20, further comprising a motor in communication with the controller, the motor configured to:
receive the signal for changing the position of the autonomous system from the controller, and
supply a force to change the position of the autonomous system.

23. The autonomous system of claim 20, further comprising an autonomous vehicle carrying the sensor and the controller, and wherein the autonomous vehicle comprises at least one of an autonomous aircraft, an autonomous automobile, or an autonomous robot.

24. The autonomous system of claim 20, wherein the electromagnetic energy emitter module comprises a holographic filter to diffract the electromagnetic energy beam in different directions.

25.-47. (canceled)
